(19) United States
(12) Patent Application Publication
(10) Pub. No.: US 2015/0148488 A1
(43) Pub. Date: May 28, 2015

(54) Impact Resistant Compositions Of Thermoplastic Polyamides And Modified Block Copolymers For Use In Tubes, Pipes, And Hoses

(71) Applicant: KRATON POLYMERS U.S. LLC, Houston, TX (US)

(72) Inventors: Marcus GREGER, Amsterdam (DE); Hendrik DE GROOT, Hamme-Mille (NL)

(73) Assignee: KRATON POLYMERS U.S. LLC, Houston, TX (US)

(21) Appl. No.: 14/088,853

(22) Filed: Nov. 25, 2013

(51) Int. Cl. C08L 77/02; C08L 77/06

(52) U.S. Cl. CPC C08L 77/02; C08L 77/06
USPC 525/66

(57) ABSTRACT

The present invention provides for a thermoplastic composition that includes from about 40 to about 95 wt. % of a polyamide, and from about 5 to about 30 wt. % of at least one functionalized, selectively hydrogenated block copolymer, including at least one polymer block A, the A block being at least predominantly a polymerized alkenyl arene block, and at least one selectively hydrogenated polymer block B, the B block prior to hydrogenation being at least predominantly a polymerized conjugated diene block to which grafted thereto on the average an effective amount of monomer acids or their derivatives, including maleic acid, succinic acid, itaconic acid, fumaric acid, and acrylic acid. The composition optionally includes from about 5 to about 50 wt. % of a selectively hydrogenated block copolymer.

### FIELD OF THE INVENTION

The present invention relates to an impact resistant thermoplastic composition for use in tubes, pipes, and hoses. More particularly, it relates to an impact resistant thermoplastic composition comprising a polyamide, a functionalized hydrogenated block copolymer and, optionally a hydrogenated block copolymer. Polyamide and α-polyamide as used herein refers to polyamide 6. The hydrogenated block copolymer is composed of a selectively hydrogenated conjugated diene polymer block and an alkenyl arene polymer block. In forming a functionalized hydrogenated block copolymer, an effective amount of monomer acids or their derivatives are grafted thereto.

### BACKGROUND OF THE INVENTION

Thermoplastic polyamides, such as polyamide 6, 6.6, 6.10, etc., are a class of materials which possess a good balance of properties comprising good elongation, high strength, high energy to break and stiffness which make them useful as structural materials. However, thermoplastic polyamides are quite sensitive to crack propagation. Consequently, a major deficiency of thermoplastic polyamides is their poor resistance to impact and their tendency to break in a brittle rather than ductile manner, especially when dry.

It is well known to those skilled in the art that hydrogenated block copolymers of styrene and butadiene possess many of the properties useful for impact modification of plastics. These low modulus rubber materials display a low glass transition temperature, a characteristic advantageous for optimum toughening at lower temperatures. Furthermore, these block copolymers contain little unsaturation which facilitates their blending with high processing temperature plastics without significant degradation of the elastomer phase.

Block copolymers are unique impact modifiers compared to other rubbers in that they contain blocks which are microphase separated over the range of applications and processing conditions. These polymer segments may be tailored to become miscible with the resin to be modified. Good particle-matrix adhesion is obtained when different segments of the block copolymer reside in the matrix and in the rubber phase. This behavior is observed when hydrogenated block copolymer of styrene and butadiene are blended with resins such as polyolefins and polystyrene. Impact properties competitive with high impact polystyrene are obtained due to the compatibility of polystyrene with the polystyrene endblock of the block copolymer. Other polyolefins are toughened due to enhanced compatibility with the rubber segment.

Although the hydrogenated block copolymers do have many of the characteristics required for plastic impact modification, these materials are deficient as impact modifiers for many materials which are dissimilar in structure to styrene or hydrogenated butadiene. In particular, significant improvement in the impact resistance of polyamides with the addition of these hydrocarbon polymers has not been achieved. This result is due to poor interfacial interaction between the composition components and poor dispersion of the rubber particles. Poor interfacial adhesion affords areas of severe weakness in articles manufactured from such compositions which when under impact result in facile mechanical failure.

Polyamide 12 is used in many applications, including pneumatic brake hoses for heavy truck vehicles. It is an object of the present invention to provide a thermoplastic composition that exhibits similar characteristics as polyamide 12 and perform similarly under tensile stress, elongation, and notched Izod impact tests.

### BRIEF SUMMARY OF THE INVENTION

According to the present invention, there is provided a thermoplastic composition comprising i) a thermoplastic alpha (α)-polyamide or an alpha-omega (α-ω)-polyamide, ii) a functionalized hydrogenated alkenyl arene/conjugated diene block copolymer, and optionally iii) a hydrogenated alkenyl arene/conjugated diene block copolymer.

More particularly, there is provided a thermoplastic composition comprising:
a) a thermoplastic polyamide, exclusive of polyamide 12;
b) at least one functionalized hydrogenated block copolymer and,
c) optionally, at least one hydrogenated block copolymer, wherein
d) the polyamide is an α-polyamide or an α-ω-polyamide,
e) the hydrogenated block copolymer of component b comprises
   i) at least one polymer block A, the A block being at least predominantly a polymerized alkenyl arene block, and
   ii) at least one selectively hydrogenated polymer block B, the B block prior to hydrogenation being at least predominantly a polymerized conjugated diene block,
   iii) the block copolymer is functionalized by grafting thereto on the average an effective amount of monomer acids or their derivatives, including maleic acid, succinic acid, itaconic acid, fumaric acid, and acrylic acid, and
f) the optional hydrogenated block copolymer of component c is a block copolymer which comprises
   i) at least one polymer block A, the A block being at least predominantly a polymerized alkenyl arene block, and
   ii) at least one selectively hydrogenated polymer block B, the B block prior to hydrogenation being at least predominantly a polymerized conjugated diene block.

The thermoplastic composition includes:

from about 40 to about 95 wt. % of a thermoplastic α-polyamide or an α-ω-polyamide, exclusive of polyamide 12;
i) from about 5 to about 30 wt. % of at least one functionalized, selectively hydrogenated block copolymer, at least one polymer block A, the A block being at least predominantly a polymerized alkenyl arene block, and at least one selectively hydrogenated polymer block B, the B block prior to hydrogenation being at least predominantly a polymerized conjugated diene block to which grafted thereto on the average an effective amount of monomer acids or their derivatives, including maleic acid, succinic acid, itaconic acid, fumaric acid, and acrylic acid; and
ii) optionally, from about 5 to about 50 wt. % of a selectively hydrogenated block copolymer which comprises at least one polymer block A, the A block being at least predominantly a polymerized alkenyl arene block, and at least one selectively hydrogenated polymer block B, the B block prior to hydrogenation being at least predominantly a polymerized conjugated diene block.

The hydrogenated block copolymer of (ii) and/or (iii) above may have the general configuration A-B-A, (A-B)n, (A-B-A)n, (A-B-A)nX, (A-B)nX or mixtures thereof, where n is an integer from 2 to about 30, and X is coupling agent residue and wherein:
a) prior to hydrogenation each A block is at least predominately a polymerized alkenyl arene block and each B block is being at least predominantly a polymerized conjugated diene block;
b) subsequent to hydrogenation about 0-10% of the arene double bonds have been reduced, and at least about 90% of the conjugated diene double bonds have been reduced;
c) each A block has a number average molecular weight from about 5.0 to about 35 kg/mol and, wherein the linear hydrogenated block copolymer has a total apparent number average molecular weight from about 70 to about 300 kg/mol and the branched hydrogenated block copolymer has a total apparent number average molecular weight from about 35 to about 150 kg/mol per arm
d) each B block being at least predominantly a polymerized conjugated diene;
e) the total amount of mono alkenyl arene in the hydrogenated block copolymer is from about 10 to about 45 weight percent; and
f) the weight percent of mono alkenyl arene in each B block may vary from about 0 to about 40 weight percent.

The blocks A of the functionalized block copolymer and the optional block copolymer may be polymer blocks of the same or different alkenyl arene. Likewise, the blocks B may be polymer blocks of the same or a different conjugated diene. As such, the first and second block copolymers may be the same or different block copolymer.

The hydrogenated block copolymer may be formed sequentially or radially, or a mixture thereof. Preferably, the hydrogenated block copolymer is a selectively hydrogenated styrenic block copolymer having the formula styrene-ethylene/butadiene-styrene (SEBS). When SEBS is the main hydrogenated styrenic block copolymer (b), generally at least a minor portion of the SEBS is a functionalized SEBS. The functionalized styrenic block copolymer is grafted onto the polymer backbone, with a monomer acid or its derivatives such as anhydrides, wherein suitable monomer acids or their derivatives include maleic acid, succinic acid, itaconic acid, fumaric acid, or acrylic acid. Furthermore, the term “radially” also includes symmetric or asymmetric radial and star structures.

### DETAILED DESCRIPTION OF THE INVENTION

The ranges set forth in this specification included not only each end number but also every conceivable number in between the end number, as this is the very definition of a range.

The term “monoalkenyl arene” will be taken to include particularly those of the benzene series such as styrene and its analogs and homologs including o-methylstyrene, p-methylstyrene, p-tert-butylstyrene, 1,3-dimethylstyrene, alpha-methylstyrene and other ring alkylated styrenes, particularly ring-methylated styrenes, and other monoalkenyl polycyclic aromatic compounds such as vinyl naphthalene, vinyl anthracene and the like and mixtures thereof. The preferred monoalkenyl arenes are monovinyl monocyclic arenes such as styrene and alpha-methylstyrene, and styrene is particularly preferred.

The conjugated dienes are preferably ones containing from 4 to 8 carbon atoms. Examples of such suitable conjugated diene monomers include: 1,3-butadiene (butadiene), 2-methyl-1,3-butadiene (isoprene), 2,3-dimethyl-1,3-butadiene, 1,3-pentadiene (piperylene), 1,3-hexadiene, and the like. Mixtures of such conjugated dienes may also be used. The preferred conjugated dienes are butadiene and isoprene.

These starting monomers for preparing a hydrogenated styrene-butadiene-styrene are reacted by sequential polymerization or coupling. In sequential polymerization an amount of styrene monomer is anionically reacted in a solvent with an initiator to form a block of polystyrene. This process is repeated for butadiene. Butadiene monomer is added to the reactor and the polybutadiene attaches to the styrene block forming SB diblock copolymer. Lastly more styrene monomer is added to the reactor, and the styrene attaches to the SB block and forms another styrene block copolymer—SBS. Thereafter, the SBS can be hydrogenated by exposing the SBS to hydrogen, as set forth below.

For coupling, SB is formed by the above process. Then the many polymerized SB diblock units are coupled together (SB)nX to form SBS, using a coupling agent, where X is the residue of a coupling agent as explained hereinafter, and n is a number equal to 2 or more.

An important starting material for anionic co-polymerizations is one or more polymerization initiators, as mentioned previously. In the present invention such include, for example, alkyl lithium compounds and other organolithium compounds such as s-butyllithium, n-butyllithium, t-butyllithium, amyllithium and the like, including di-initiators such as the di-sec-butyl lithium adduct of m-diisopropenyl benzene. Other such di-initiators are disclosed in U.S. Pat. No. 6,492,469. Of the various polymerization initiators, s-butyllithium is preferred. The initiator can be used in the polymerization mixture (including monomers and solvent) in an amount calculated on the basis of one initiator molecule per desired polymer chain. The lithium initiator process is well known and is described in, for example, U.S. Pat. Nos. 4,039,593 and Re. 27,145, which descriptions are incorporated herein by reference.

The solvent used as the polymerization vehicle may be any hydrocarbon that does not react with the living anionic chain end of the forming polymer, is easily handled in commercial polymerization units, and offers the appropriate solubility characteristics for the product polymer. For example, non-polar aliphatic hydrocarbons, which are generally lacking in ionizable hydrogens make particularly suitable solvents. Frequently used are cyclic alkanes, such as cyclopentane, cyclohexane, cycloheptane, and cyclooctane, all of which are relatively non-polar. Other suitable solvents will be known to one skilled in the art and can be selected to perform effectively in a given set of process conditions, with temperature being one of the major factors taken into consideration.

Preparation of radial (branched) polymers requires a post-polymerization step called “coupling”. In the above radial formula for the selectively hydrogenated block copolymer, n is an integer of from 2 to about 30, preferably from about 2 to about 15, and X is the remnant or residue of a coupling agent. A variety of coupling agents are known in the art and include, for example, dihalo alkanes, silicon halides, siloxanes, multifunctional epoxides, silica compounds, esters of monohydric alcohols with carboxylic acids, (e.g. dimethyl adipate) and epoxidized oils. Star-shaped polymers are prepared with polyalkenyl coupling agents as disclosed in, for example, U.S. Pat. Nos. 3,985,830; 4,391,949; and 4,444,953; Canadian Pat.716,645. Suitable polyalkenyl coupling agents include divinylbenzene, and preferably m-divinylbenzene. Preferred are tetra-alkoxysilanes such as tetra-ethoxysilane (TEOS) and tetra-methoxysilane, alkyl-trialkoxysilanes such as methyl-trimethoxy silane (MTMS), aliphatic diesters such as dimethyl adipate and diethyl adipate, and diglycidyl aromatic epoxy compounds such as diglycidyl ethers deriving from the reaction of bis-phenol A and epichlorohydrin.

Coupling efficiency is of critical importance in the synthesis of block copolymers, which copolymers are prepared by a linking technology. In a typical anionic polymer synthesis, prior to the coupling reaction, the unlinked arm has only one hard segment (typically polystyrene). Two hard segments are required in the block copolymer if it is to contribute to the strength mechanism of the material. Uncoupled diblock arms dilute the strength forming network of a block copolymer that weakens the material. The very high coupling efficiency realized in the present invention is key to making high strength, coupled, block copolymers. The coupling efficiency of the present invention is from about 40% to about 100%, and preferably from about 60% to about 95%.

It is well known in the art to modify the polymerization of the conjugated diene block to control the vinyl content. Broadly, this can be done by utilizing an organic polar compound such as an ether, including cyclic ethers, polyethers and thioethers or an amine including secondary and tertiary amines. Both non-chelating and chelating polar compounds can be used.

Among the polar compounds which may be added in accordance with one aspect of this invention are dimethyl ether, diethyl ether, ethyl methyl ether, ethyl propyl ether, dioxane, dibenzyl ether, diphenyl ether, dimethyl sulfide, diethyl sulfide, tetramethylene oxide (tetrahydrofuran), tripropyl amine, tributyl amine, trimethyl amine, triethyl amine, pyridine and quinoline and mixtures thereof.

In the present invention “chelating ether” means an ether having more than one oxygen as exemplified by the formula R(OR′)m (OR″)o OR where each R is individually selected from 1 to 8, preferably 2 to 3, carbon atom alkyl radicals; R′ and R″ are individually selected from 1 to 6, preferably 2 to 3, carbon atom alkylene radicals; and m and o are independently selected integers of 1-3, preferably 1-2. Examples of preferred ethers include diethoxypropane, 1,2-dioxyethane (dioxo) and 1,2-dimethyoxyethane (glyme). Other suitable materials include —CH₃, —OCH₂, —CH₂, and —OCH₃ (diglyme). “Chelating amine” means an amine having more than one nitrogen such as N,N,N′,N′-tetramethylethylene diamine.

The amount of polar modifier is controlled in order to obtain the desired vinyl content in the conjugated diene block. The polar modifier is used in an amount of at least 0.1 moles per mole of lithium compound, preferably 1-50, more preferably 2-25, moles of polar modifier per mole of the lithium compound. Alternatively, the concentration can be expressed in parts per million by weight based on the total weight of solvent and monomer. Based on this criteria from 10 parts per million to about 1 weight percent, preferably 100 parts per million to 2000 parts per million are used. This can vary widely, however, since extremely small amounts of some of the preferred modifiers are very effective. At the other extreme, particularly with less effective modifiers, the modifier itself can be the solvent. Again, these techniques are well known in the art, disclosed for instance in Winkler, U.S. Pat. No. 3,686,366 (Aug. 22, 1972), Winkler, U.S. Pat. No. 3,700,748 (Oct. 24, 1972) and Koppes et al., U.S. Pat. No. 5,194,535 (Mar. 16, 1993), the disclosures of which are hereby incorporated by reference.

### Polyamides

By polyamide is meant a condensation product which contains recurring aromatic and/or aliphatic amide groups as integral parts of the main polymer chain, such products being known generically as “polyamides.” The polyamide matrix of the toughened compositions of this invention is well known in the art and embraces those semi-crystalline and amorphous resins having a molecular weight of at least 5000 having a linear or branched structure.

By “α-polyamides” is meant those polyamides having only one terminal group which strongly interacts or is reactive with the carboxyl functional groups of the block copolymer utilized in the compositions herein, such as an amine group. Examples of such α-polyamides are those polyamides that may be obtained by polymerizing a monoaminocarboxylic acid or an internal lactam thereof having at least two carbon atoms between the amino and carboxylic acid groups thereof. Alpha-polyamides are polyamide 4, polyamide 6, polyamide 7, polyamide 8, polyamide 9, and polyamide 11. While polyamide 12 is also a α-polyamide, this is the polyamide the present invention seeks to replace. The preferred α-polyamide which may be incorporated into the thermoplastic polymer composition of the present invention is polyamide 6.

As examples of the said monoaminocarboxylic acids or lactams thereof, there may be mentioned those compounds containing from 2 to 16 carbon atoms between the amino and carboxylic acid groups, said carbon atoms forming a ring with the —CO—NH— group in the case of a lactam. As particular examples of aminocarboxylic acids and lactams there may be mentioned ε-aminocaproic acid, butyrolactam, pivalolactam, caprolactam, capryllactam, enantholactam, undecanolactam, dodecanolactam and 3- and 4-amino benzoic acids. Preferably, caprolactam is utilized.

The amount of polyamide included in such compositions may vary widely depending upon the properties desired in the composition. For example, as great as 90 wt. % of the composition may be composed of polyamide. However, the amounts of α-polyamide included in the compositions of the present invention preferably range from about 50 to about 80 wt. % based on total weight of the α-polyamide and the block copolymers. More preferably, the amounts of α-polyamide are from about 60 to about 80 wt. % based on total weight of the α-polyamide and the block copolymers.

By “α,ω-polyamides” is meant those polyamides having at least two terminal groups, e.g. on each end of a linear polyamide, which are reactive with the carboxyl functional groups of the block copolymer utilized in the compositions herein. Preferably, these terminal groups are amines. Examples of such α,ω-polyamides are those polyamides that may be obtained by polymerizing a diamine which contains at least two carbon atoms between the amino groups thereof and a dicarboxylic acid or ester thereof. Suitable α,ω-polyamides include those described in U.S. Pat. Nos. 2,071,250; 2,071,251; 2,130,523; 2,130,948; and 3,393,210, the disclosures of which are herein incorporated by reference.

Typically these polyamides are prepared by polymerizing substantially equimolar proportions of the diamine and the dicarboxylic acid. Furthermore, excess diamine may be employed to provide an excess of amine end groups over carboxyl end groups in the polyamide.

The term “substantially equimolecular proportions” (of the diamine and of the dicarboxylic acid) is used to cover both strict equimolecular proportions and the slight departures therefrom which are involved in conventional techniques for stabilizing the viscosity of the resultant polyamides.

Examples of the said diamines are diamines of the general formula H2N(CH2)nNH2 wherein n is an integer of from 2 to 16, such as trimethylenediamine, tetramethylenediamine, pentamethylenediamine, octamethylenediamine, decamethylenediamine, dodecamethylenediamine, hexadecamethylenediamine, and especially hexamethylenediamine.

The said dicarboxylic acids may be aromatic, for example isophthalic and terephthalic acids. Preferred dicarboxylic acids are of the formula HOOC—Y—COOH wherein Y represents a divalent aliphatic radical containing at least 2 carbon atoms, and example of such acids are sebacic acid, octadecanedioic acid, suberic acid, azelaic acid, undecanedioic acid, glutaric acid, pimelic acid, and especially adipic acid. Oxalic acid is also a preferred acid. Furthermore, the dicarboxylic acid may be used in the form of a functional derivative thereof, for example an ester.

Illustrative examples of α,ω-polyamides which may be incorporated in the thermoplastic polymer blends of the invention include:

polyamide 4.6;

polyamide 4.10;

polyamide 6.6;

polyamide 6.9;

polyamide 6.10;

polyamide 6.12;

polyamide 10.10; and

polyamide 12.12.

It is also possible to use in this invention polyamides prepared by the copolymerization of two or more of the above polymers or terpolymerization of the above polymers or their components.

### Hydrogenated Block Copolymer

The selectively hydrogenated block copolymers employed in the present invention may have a variety of geometrical structures, since the invention does not depend on any specific geometrical structure, but rather upon the chemical constitution of each of the polymer blocks, and subsequent modification of the block copolymer. The precursor of the first and second base block copolymers employed in the present composition are preferably thermoplastic elastomers and have at least one alkenyl arene polymer block A and at least one elastomeric conjugated diene polymer block B. The number of blocks in the block copolymer is not of special importance and the macromolecular configuration may be linear or branched, which includes graft, radial or star configurations, depending upon the method by which the block copolymer is formed.

The selectively hydrogenated mono alkyl arene—conjugated diene block copolymers may have a linear configuration such as A-B-A. The block copolymers can also be structured to form a branched (branched) polymer, (A-B)ₙX or (A-B-A)ₙX, or both branched and linear types of structures can be combined in a mixture. Some A-B diblock polymer can be present up to about 30 weight percent of the hydrogenated styrenic block copolymer, but preferably at least about 70 weight percent of the block copolymer is A-B-A or branched (or otherwise branched so as to have 2 or more terminal resinous blocks per molecule) so as to impart strength. Other structures include (A-B)ₙ and (A-B)ₙA. In the above formulas, n is an integer from about 2 to about 30, preferably from about 2 to about 15, more preferably from about 2 to 6 and X is the remnant or residue of the coupling agent.

It will be understood that block A may be either homopolymer, random or tapered copolymer blocks of alkenyl arene. For example, block A may comprise styrene/alpha-methylstyrene copolymer blocks or tapered copolymer blocks as long as the blocks individually at least predominate in alkenyl arenes. The A blocks are preferably styrene.

The blocks B may comprise homopolymers of conjugated diene monomers, copolymers of two or more conjugated dienes, and controlled distribution B blocks. Block copolymers having a controlled distribution block B are known and have been described in EP 1474458 A. For purposes hereof, “controlled distribution” is defined as referring to a molecular structure having the following attributes: (1) terminal regions adjacent to the mono alkenyl arene homopolymer (“A”) blocks that are rich in (i.e., have a greater than average amount of) conjugated diene units; (2) one or more regions not adjacent to the A blocks that are rich in (i.e., have a greater than average amount of) mono alkenyl arene units; and (3) an overall structure having relatively low blockiness. For the purposes hereof, “rich in” is defined as greater than the average amount, preferably greater than 5% the average amount.

The styrene blockiness index is simply the percentage of blocky styrene (or other alkenyl arene) to total styrene units: Blocky %=100 times (Blocky Styrene Units/Total Styrene Units). For the present invention, it is preferred that the styrene blockiness index of block B be less than about 10.

Preferably, the controlled distribution copolymer block has three distinct regions—conjugated diene rich regions on the end of the block and a mono alkenyl arene rich region near the middle or center of the block. Typically the region adjacent to the A block comprises the first 15 to 25% of the block and comprises the diene rich region(s), with the remainder considered to be arene rich. The term “diene rich” means that the region has a measurably higher ratio of diene to arene than the arene rich region. What is desired is a mono alkenyl arene/conjugated diene controlled distribution copolymer block, wherein the proportion of mono alkenyl arene units increases gradually to a maximum near the middle or center of the block (when describing an ABA structure) and then decreases gradually until the polymer block is fully polymerized. This structure is distinct and different from the tapered and/or random structures discussed in the prior art.

Suitable hydrogenated SBS block copolymer, also known as styrene-ethylene/butylene-styrene (SEBS), are available from Kraton type G block copolymers such as G1640, G1641, G1642, G1643, G1645, G1650, G1651, G1652, G1654, G1657, etc. may be used in the present invention. In the compositions of the present invention, the SEBS is optionally present in a range from about 5 to about 30 wt. %, including all ranges there between.

Other suitable polymers are available from Kraton type A block copolymers, such as A1536, MD6951. Furthermore, hydrogenated SIS block copolymers, also known as styrene-ethylene/propylene (SEPS), such as Kraton G1730 may also be utilized.

To produce a functionalized SEBS, U.S. Pat. No. 4,578,429 to Gergen discloses how a styrenic block copolymer is grafted with an effective amount monomer acid or its derivatives such as anhydrides, wherein suitable monomer acids or their derivatives include maleic acid, succinic acid, itaconic acid, fumaric acid, and acrylic acid. This reference is hereby incorporated by reference. “Effective amount” means the amount of monomer acid or its derivatives that is sufficient to graft a functional group. Suitable maleic anhydride functionalized SEBS are available from Kraton as types FG1901, FG1924, RP6670 etc. Other functionalized SEBS, such as MD6684, are also known and acceptable. In the compositions of the present invention, functionalized SEBS is present in a range from about 5 to about 20 wt. %, including all ranges there between.

### Selective Hydrogenation

Hydrogenation can be carried out via any of the several hydrogenation or selective hydrogenation processes known in the prior art. For example, such hydrogenation has been accomplished using methods such as those taught in, for example, U.S. Pat. Nos. 3,595,942; 3,634,549; 3,670,054; 3,700,633; and Re. 27,145, the disclosures of which are incorporated herein by reference. These methods operate to hydrogenate polymers containing aromatic or ethylenic unsaturation and are based upon operation of a suitable catalyst. Such catalyst, or catalyst precursor, preferably comprises a Group VIII metal such as nickel or cobalt which is combined with a suitable reducing agent such as an aluminum alkyl or hydride of a metal selected from Groups I-A, II-A and III-B of the Periodic Table of the Elements, particularly lithium, magnesium or aluminum. This preparation can be accomplished in a suitable solvent or diluent at a temperature from about 20° C. to about 80° C. Other catalysts that are useful include titanium based catalyst systems.

Hydrogenation can be carried out under such conditions that at least about 90 percent of the conjugated diene double bonds have been reduced, and between zero and 10 percent of the arene double bonds have been reduced. Preferred ranges are at least about 95 percent of the conjugated diene double bonds reduced, and more preferably about 98 percent of the conjugated diene double bonds are reduced. Alternatively, it is possible to hydrogenate the polymer such that aromatic unsaturation is also reduced beyond the 10 percent level mentioned above. Such exhaustive hydrogenation is usually achieved at higher temperatures. In that case, the double bonds of both the conjugated diene and arene may be reduced by 90 percent or more.

Once the hydrogenation is complete, it is preferable to extract the catalyst by stirring with the polymer solution a relatively large amount of aqueous acid (preferably 20-30 percent by weight), at a volume ratio of about 0.5 parts aqueous acid to 1 part polymer solution. Suitable acids include phosphoric acid, sulfuric acid and organic acids. This stirring is continued at about 50° C. for about 30 to about 60 minutes while sparging with a mixture of oxygen in nitrogen. Care must be exercised in this step to avoid forming an explosive mixture of oxygen and hydrocarbons.

It is also important to control the molecular weight of the various blocks. Desired number average block weights are from about 5.0 to about 35 kg/mol for the mono alkenyl arene A block. For the triblock, which may be a sequential ABA or coupled (AB)2 X block copolymer, the total apparent number average molecular weight should be from about 70 to about 300 kg/mol, preferably from about 100 to about 250 kg/mol, and for the coupled copolymer from about 35 to about 150 kg/mol per arm, preferably from about 62.5 to about 150 kg/mol per arm. With the expression “apparent”, as used throughout the specification, is meant the molecular weight of a polymer as measured with gel permeation chromatography (GPC) also referred to as Size Exclusion Chromatography (SEC) using polystyrene calibration standards (using a method analogue to the method described in ASTM D5296-05). Reference is made herein to number average molecular weight. The molecular weight distribution (Mw/Mn) for anionically polymerized polymers is small. Therefore, as is common in the art, as number average molecular weight the peak position is used, since the differences between the peak molecular weight (Mp) and the number average molecular weight (Mn) are very small. Another important aspect of the present invention is to control the microstructure or vinyl content of the conjugated diene in the block copolymer. The term “vinyl content” refers to the fact that a conjugated diene is polymerized via 1,2-addition (in the case of butadiene—it would be 3,4-addition in the case of isoprene). Thus, “vinyl” in no way refers to PVC. The vinyl content of the functionalized and non-functionalized SEBS polymers used in the present invention is between about 20 mol % to about 80 mol %.

The compositions of the present invention can be readily molded or formed into various kinds of useful articles by using any conventional molding, injection molding, blow molding, pressure forming, rotational molding and the like. Examples of the articles are tubes, pipes, and hoses, including corrugated tubes, clutch pipes, clutch hoses, single layer pneumatic hoses, single layer pneumatic brake hoses, single layer spiral hoses containing a steel or plastic wire, and multi-layer spiral hoses containing a steel or plastic wire and fiber reinforcement.

The thermoplastic compositions of the present invention can further contain other conventional additives. Examples of such additives are stabilizers and inhibitors of oxidative, thermal, and ultraviolet light degradation. The stabilizers can be incorporated into the composition at any stage in the preparation of the composition. Preferably, the stabilizers are included early to preclude the initiation of degradation before the composition can be protected. Such stabilizers must be compatible with the composition. Suitable stabilizers are sold under the tradename Irganox 1010 and Irgafos 168 that can be purchased from BASF (formally Ciba). The thermoplastic composition can contain from about 0.1 wt. % to about 1.0 wt. % of stabilizer.

The thermoplastic composition of the present invention has a MFR of less than 30 at 230° C./5.0 Kg, and preferably less than 20 at 230° C./5.0 Kg, a shore D hardness of between about 60 to about 70, a tensile strength of between about 20 MPa to about 60 MPa, a tensile strength at 100% elongation of between about 20 MPa to about 60 MPa, and an elongation at break of equal to or greater than about 100%, and preferably between about 100% to about 400%.

To assist those skilled in the art in the practice of this invention, the following Examples are set forth as illustrations. It is to be understood that in the specification and claims herein, unless otherwise indicated, when the amount of the polyamide or block copolymer is expressed in terms of percent by weight, it is meant percent by weight based on the total amount of the composition.

The following test methods are used to characterize the thermoplastic composition:

Melt Flow Rate: ASTM-D 1238

Elongation at break: ISO 527

Shore D: ASTM D2240

Tensile Strength: ISO 527 at 23° C.

Tensile Strength at 100% Elongation: ASTM D638 at 23° C.

Notched Izod Strength: at each end ASTM D-256

It is a goal that each of the properties exhibited by the thermoplastic composition of the present invention exhibit properties similar to that of polyamide 12 for the test procedures and analytical methods above. Specifically, it is desired that the thermoplastic composition exhibit a MFR between 4 and 15 at 230° C./5.0 Kg, 60-65 Shore D hardness, 25-50 MPa Tensile Strength, 25-40 MPa TS at 100% elongation, 300-400% elongation at break, and notched IZOD impact of 75-85 KJ/m2.

### EXAMPLES

### Example 1

In this example, samples 1 through 4 were composed in accordance with Table 1.

TABLE 1

| | Sample 1 | Sample 2 | Sample 3 | Sample 4 |
|---|---|---|---|---|
| Ingredient | Wt. % | Wt. % | Wt. % | Wt. % |
| Ultramid B3K | 80 | 80 | 80 | 80 |
| FG 1901 | 20 | | | 10 |
| FG 1924 | | 20 | | |
| MD 6684 | | | 20 | |
| G 1657 | | | | 10 |
| Irganox 1010 | 0.2 | 0.2 | 0.2 | 0.2 |
| Irgafos 168 | 0.4 | 0.4 | 0.4 | 0.4 |

The compositions in Table 1 were manufactured by drying the polyamide 6 (Ultramid B3K) for 6 hours at 100° C., while the functionalized maleated styrenic block (FG1901, FG1924, or MD6684) and the hydrogenated block copolymer (Kraton G1657) were dried for 6 hours at 60° C. The compounds were produced on the Coperion 26 mm co-rotating screw extruder at a throughput of 12 kg/h and screw speed of 300 rpm. The resulting compounds were dried for 6 hours at 80° C. before injection molding of the test specimen into directly injected tensile bars DIN ISO 527 Type 1B. The mechanical properties were measured on conditioned samples (4 days at 23° C. at 50% humidity). The Melt Flow Rate, Shore D hardness, tensile strength, tensile strength at 100% elongation, and elongation at break were measured on the samples and the comparative example polymer 6 (Ultramid B3K). The testing speed is set at 100 mm/min. The results for these comparative samples are produced in Table 2:

TABLE 2

| | MFR | | Tensile | TS at 100% | Elongation |
|---|---|---|---|---|---|
| | 230° C./ | | Strength | Elongation | at Break |
| | 5.0 kg | Shore D | MPa | MPa | % |
| Ultramid B3K | 49 | 66 | 72 | 0 | 62 |
| Sample 1 | 14 | 64 | 47 | 38 | 232 |
| Sample 2 | 20 | 64 | 41 | 36 | 272 |
| Sample 3 | 14 | 66 | 40 | 38 | 305 |
| Sample 4 | 25 | 64 | 43 | 37 | 331 |

### Example 2

Samples 5 and 6 were formulated in accordance with Table 3.

TABLE 3

| | Sample 5 | Sample 6 |
|---|---|---|
| Ultramide B3K | 70 | 60 |
| FG1901 | 10 | 10 |
| G1657 | 20 | 30 |
| Irganox 1010 | 0.1 | 0.1 |
| Irgafos 168 | 0.2 | 0.2 |

The compositions in Table 3 were manufactured by drying the polyamide 6 (Ultramid B3K) for 6 hours at 100° C., while the functionalized polymer (FG 1901) and the block copolymer (Kraton G1657) were dried for 6 hours at 60° C. The compounds were produced on the Coperion 26 mm co-rotating screw extruder at a throughput of 12 kg/h and screw speed of 300 rpm. The resulting compounds were dried for 6 hours at 80° C. before injection molding of the test specimen into tensile bars and tested according to DIN ISO 527 Type 1B. The mechanical properties were measured on conditioned samples (4 days at 23° C. at 50% humidity). The Melt Flow Rate, Shore D hardness, tensile strength, tensile strength at 100% elongation, and elongation at break were measured on the samples and the example polyamide 6 (Ultramid B3K) and polyamide 12 (Grilamid L25W40X). The testing speed is set at 100 mm/min. The results for these samples are produced in Table 4:

TABLE 4

| | MFR | | Tensile | TS at 100% | Elongation |
|---|---|---|---|---|---|
| | 230° C./ | | Strength | Elongation | at Break |
| | 5.0 Kg | Shore D | MPa | MPa | % |
| Ultramid B3K | 49 | 66 | 72 | 0 | 62 |
| Grilamid | 5 | 62 | 35 | 27 | 321 |
| L25W40X | | | | | |
| Sample 5 | 13 | 61 | 27 | 30 | 389 |
| Sample 6 | 8 | 61 | 27 | 25 | 321 |

In comparing the Examples, the desire is to develop a composition that has similar properties to the target values of polyamide 12 (Grilamid L25W40X in the examples). Examples 5 and 6 with the higher levels of Kraton® G1657 exhibited properties close to the target values of Grilamid L25W40X. As shown in Table 4, the values of Samples 5 and 6 are within the target values of Grilamid L25W40X (MFR, Shore D, Tensile Strength, and Elongation). Additionally, a notched IZOD impact test (according to ASTM D-790) was performed on ten samples of polyamide 12 and a thermoplastic composition made in accordance with the present invention. The polyamide 12 notched IZOD impact test was calculated as 78 kJ/m², and the notched IZOD impact test for the thermoplastic of the present invention was calculated to be from about 80 kJ/m² to about 85 kJ/m².

1. A thermoplastic composition, comprising:
i) from about 40 to about 95 wt. % of a polyamide, excluding polyamide 12;
ii) from about 5 to about 30 wt. % of at least one functionalized, selectively hydrogenated block copolymer, to which grafted thereto on the average an effective amount of monomer acids or their derivatives, including maleic acid, succinic acid, itaconic acid, and fumaric acid; and
iii) optionally, from about 5 to about 50 wt. % of a selectively hydrogenated block copolymer.

2. The thermoplastic composition according to claim 1, wherein the polyamide is polyamide 6.

3. The thermoplastic composition according to claim 1, wherein the polyamide is selected from the group consisting of polyamide 6.6, polyamide 6.10, polyamide 4.6, polyamide 4.10, and polyamide 10.10 including derivatives and mixtures thereof.

4. The thermoplastic composition according to claim 1, wherein the functionalized selectively hydrogenated block copolymer (ii), is composed of at least one polymer block A, the A block being at least predominately a polymerized alkenyl arene block, and at least one selectively hydrogenated polymer block B, the B block prior to hydrogenation being at least predominantly a polymerized conjugated diene block.

5. The thermoplastic composition according to claim 1, wherein the hydrogenated block copolymer (iii) is linear and has the formula SEBS or SEPS.

6. The thermoplastic composition according to claim 1, wherein the functionalized selectively hydrogenated block copolymer (ii) or hydrogentated block copolymer (iii) comprises the general formula A-B, A-B-A, (A-B)n, (A-B-A)n, (A-B-A)nX, (A-B)nX or mixtures thereof, where n is an integer from 2 to about 30, and X is a coupling agent residue.

7. The thermoplastic composition according to claim 1, wherein the thermoplastic composition has a tensile strength of between about 20 to about 60 MPa.

8. The thermoplastic composition according to claim 1, wherein the thermoplastic composition has a tensile strength at 100% elongation of between about 20 to about 60 MPa.

9. The thermoplastic composition according to claim 1, wherein the thermoplastic composition has an elongation at break of equal to or greater than about 100%.

10. The thermoplastic composition according to claim 1, wherein the thermoplastic composition is formed into a single layer pneumatic hose.

11. A thermoplastic composition, comprising:
from about 60 to about 80 wt. % of a polyamide, exclusive of polyamide 12;
from about 5 to about 30 wt. % of at least one functionalized, selectively hydrogenated block copolymer[,] including at least one polymer block A, the A block being at least predominantly a polymerized alkenyl arene block, and at least one selectively hydrogenated polymer block B, the B block prior to hydrogenation being at least predominantly a polymerized conjugated diene block to which grafted thereto on the average an effective amount of monomer acids or their derivatives, including maleic acid, succinic acid, itaconic acid, fumaric acid, and acrylic acid; and
optionally, from about 5 to about 50 wt. % of a selectively hydrogenated block copolymer which comprises at least one polymer block A, the A block being at least predominantly a polymerized alkenyl arene block, and at least one selectively hydrogenated polymer block B, the B block prior to hydrogenation being at least predominantly a polymerized conjugated diene block.

12. The thermoplastic composition according to claim 11, wherein the hydrogenated block copolymer of (ii) and/or (iii) has the general configuration A-B-A, (A-B)n, (A-B-A)n, (A-B-A)nX, (A-B)nX or mixtures thereof, where n is an integer from 2 to about 30, and X is coupling agent residue and wherein:
a) prior to hydrogenation each A block is a mono alkenyl arene polymer block and each B block is a copolymer block of at least one conjugated diene and at least one mono alkenyl arene;
b) subsequent to hydrogenation about 0-10% of the arene double bonds have been reduced, and at least about 90% of the conjugated diene double bonds have been reduced;
c) each A block has a number average molecular weight from about 5.0 to about 35 kg/mol and, wherein the linear hydrogenated block copolymer has a total apparent number average molecular weight from about 70 to about 300 kg/mol and the branched hydrogenated block copolymer has a total apparent number average molecular weight from about 35 to about 150 kg/mol per arm
d) each B block comprises terminal regions adjacent to the A blocks that are rich in conjugated diene units and one or more regions not adjacent to the A blocks that are rich in mono alkenyl arene units;
e) the total amount of mono alkenyl arene in the hydrogenated block copolymer is from about 20 to about 45 weight percent; and
f) the weight percent of mono alkenyl arene in each B block is from about 10 to about 40 weight percent.

13. The thermoplastic composition according to claim 11, wherein the polyamide is polyamide 6.

14. The thermoplastic composition according to claim 11, wherein the polyamide is selected from the group consisting of polyamide 6.6, polyamide 6.10, polyamide 4.6, polyamide 4.10, and polyamide 10.10 including derivitives and mixtures thereof.

15. The thermoplastic composition according to claim 11, wherein the block copolymer (ii) is linear and has a total apparent number average molecular weight of between about 70 to about 300 kg/mol.

16. The thermoplastic composition according to claim 11, wherein the mono alkenyl arene is styrene and the conjugated diene is butadiene.

17. A thermoplastic composition, comprising:
from about 60 to about 80 wt. % of a polyamide, exclusive of polyamide 12;
from about 5 to about 30 wt. % of at least one functionalized, selectively hydrogenated block copolymer, at least one polymer block A, the A block being at least predominantly a polymerized alkenyl arene block, and at least one selectively hydrogenated polymer block B, the B block prior to hydrogenation being at least predominantly a polymerized conjugated diene block to which grafted thereto on the average an effective amount of monomer acids or their derivatives, including maleic acid, succinic acid, itaconic acid, fumaric acid, and acrylic acid; and
from about 5 to about 50 wt. % of a selectively hydrogenated block copolymer which comprises at least one polymer block A, the A block being at least predominantly a polymerized alkenyl arene block, and at least one selectively hydrogenated polymer block B, the B block prior to hydrogenation being at least predominantly a polymerized conjugated diene block.

18. The thermoplastic composition according to claim 17, wherein the hydrogenated block copolymer (iii) is linear and has the formula SEBS or SEPS.

19. The thermoplastic composition according to claim 17, wherein the polyamide is polyamide 6.

20. The thermoplastic composition according to claim 17, wherein the polyamide is selected from the group consisting of polyamide 6.6, polyamide 6.10, polyamide 4.6, polyamide 4.10, and polyamide 10.10 including derivitives derivatives and mixtures thereof.
